(19) United States
(12) Patent Application Publication
(10) Pub. No.: US 2004/0214006 A1
(43) Pub. Date: Oct. 28, 2004

(54) Member for a circuit board, method of manufacturing the same, and methods of manufacturing circuit boards

(75) Inventors: Kumiko Hirayama, Moriguchi-shi (JP); Fumio Echigo, Osaka-shi (JP); Izuru Nakai, Toyonaka-shi (JP); Yoji Ueda, Osaka-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/823,003

(22) Filed: Apr. 12, 2004

(30) Foreign Application Priority Data
Apr. 25, 2003 (JP) 2003-122834

(51) Int. Cl. B32B 27/38; B32B 27/08

(52) U.S. Cl. 428/416; 428/901

(57) ABSTRACT

A member for a circuit board according to the present invention includes a prepreg and a mold release film that is provided on at lease one side of the prepreg. The mold release film contains or is coated with a heat absorbing substance having a heat absorbing property. A method of manufacturing a member for a circuit board according to the present invention includes allowing a mold release film to adhere to at least one side of a prepreg by heating and pressing. The mold release film contains or is coated with a heat absorbing substance having a heat absorbing property. In the method, the heating is performed at a temperature not lower than a softening point of the prepreg and not higher than an endothermic temperature of the heat absorbing substance. Thus, a member for a circuit board that can prevent or reduce the occurrence of deformation such as contraction of a mold release film even when processing holes using a laser or the like, a method of manufacturing the same, and methods of manufacturing circuit boards are provided.

### BACKGROUND OF THE INVENTION

1. Field of the Invention

The present invention relates to a member for a circuit board that is used to form an insulating layer of a circuit board for use in electronic equipment, a method of manufacturing the same, and methods of manufacturing circuit boards. More specifically, this invention relates to a member for a circuit board that allows high-density mounting to be achieved with precision, a method of manufacturing the same, and methods of manufacturing circuit boards.

2. Related Background Art

Recent years have seen the realization of electronic equipment that is reduced in size and weight and performs high-level functions. This has led to demands for circuit boards that are smaller and more lightweight and achieve high-density mounting as well as high-speed signal processing. With respect to these demands, in the circuit board art, rapid progress should be made in technologies for achieving a multilayer structure, small-diameter via holes, fine circuit patterns and the like. However, it has been found that these demands no longer can be fulfilled easily by multilayer circuit boards having the conventional through-hole structure for establishing interlayer electrical connection. With this as a background, circuit boards with new structures and methods of manufacturing such circuit boards have been proposed. As one representative example thereof, a circuit board has been developed that has, instead of the through-hole structure that has been the mainstream of the structures for establishing interlayer connection of the conventional circuit boards, a perfect IVH (inner via hole) structure in which interlayer electrical connection is secured using a conductive paste (JP6(1994)-268345 A). The method of manufacturing this circuit board includes a process step for forming via holes for making an interlayer connection. In this process step, through-holes are formed in predetermined positions in a prepreg with a mold release film provided on each surface thereof using high-energy beams, and filled with a conductive paste by a method such as printing or the like. In the process step, the mold release film performs functions of, for example, preventing the adhesion of the conductive paste to an insulated portion other than the through-holes when the conductive paste is filled, and preventing contamination that may occur during conveyance. After the conductive paste is filled, this resin film is peeled off of the prepreg, and thus, a prepreg having via holes filled with a conductive paste can be obtained. Through the use of the prepreg, a circuit board of the perfect IVH structure further can be provided by the conventional method of forming a copper-clad laminate or a multilayer board and circuit patterning. Further, the mold release film used in this conventional process step is formed from polyethylene terephthalate (PET), polyethylene naphthalate (PEN), polypropylene (PP) or the like. Further, a face of the mold release film that is to be in contact with the prepreg may be coated with an epoxy resin layer and a mold release agent. As described above, the configuration of an insulating layer has become more complex, which has led to an increase in the importance of the capability for processing holes using a laser or the like.

However, in the case where through-holes are formed in the above-mentioned member for a circuit board, i.e. the prepreg provided with the mold release films, using high-energy beams of a laser or the like, the mold release films contract due to heat generated during processing, which is disadvantageous. For example, as shown in FIG. 8, in the case where a through-hole 13 is formed in a layer 202 of an insulating material and mold release films 201 and 201′ using high-energy beams of a laser or the like, the mold release films 201 and 201′ contract due to heat generated during processing. Particularly, the mold release film 201 provided on the side of and above the high-energy beams being irradiated contracts to a greater degree.

In recent years, there has been a demand that circuit boards achieve higher-level functions such as high rigidity and the like. With respect to this demand, a prepreg containing an organic filler or glass fibers has been in use. In order to form holes of a desired diameter in a prepreg containing an inorganic filler or glass fibers, processing is performed using higher energy for a laser. Because of this, a mold release film is heated to a higher temperature during the processing and thus contracts considerably. This contraction phenomenon is a hindrance to the achievement of a fine structure of a circuit board. If through-holes of a desired diameter are formed in the mold release film, the diameter of the through-holes formed in the prepreg becomes extremely small, thereby causing connection failure. On the other hand, in the case where through-holes are formed in the prepreg so as to have a desired diameter, the diameter of vias that are brought into contact with lands on a wiring pattern becomes large, thereby impairing the accuracy of alignment between the vias and the lands. Thus, the contraction phenomenon of a mold release film acts adversely when forming small-diameter via holes.

### SUMMARY OF THE INVENTION

In order to solve the above-mentioned problem with the conventional technique, the present invention provides a member for a circuit board that can prevent or reduce the occurrence of deformation such as contraction of a mold release film even when processing holes using a laser or the like, a method of manufacturing the same, and methods of manufacturing circuit boards.

A member for a circuit board according to the present invention includes an electrically insulating material (prepreg) and a mold release film that is provided on at lease one side of the prepreg. In the member, the mold release film contains or is coated with a heat absorbing substance having a heat absorbing property.

Next, a method of manufacturing a member for a circuit board according to the present invention includes allowing a mold release film to adhere to at least one side of a composite material (prepreg) by heating and pressing. The prepreg is formed of an electrically insulating material made of a core material and a thermosetting resin that is impregnated into the core material and brought to a semi-cured state. The mold release film contains or is coated with a heat absorbing substance having a heat absorbing property. In the method, the heating is performed at a temperature not lower than a softening point of the prepreg and not higher than an endothermic temperature of the heat absorbing substance.

Next, a first method of manufacturing a circuit board according to the present invention includes: laminating a mold release film on at least one side of a composite material (prepreg), the prepreg being formed of an electrically insulating material made of a core material and a thermosetting resin that is impregnated into the core material and brought to a semi-cured state, the mold release film containing or being coated with a heat absorbing substance having a heat absorbing property; forming through-holes in predetermined positions in a member for a circuit board using a laser, which is obtained by allowing the mold release film to adhere to the prepreg by heating and pressing at a temperature not lower than a softening point of the prepreg and not higher than an endothermic temperature of the heat absorbing substance; filling the through-holes with a conductive paste; taking out the prepreg by peeling the mold release film off of the member in which the conductive paste is filled; placing metal foil on each surface of the prepreg and subsequently performing heating and pressing so that a laminate is formed by thermocompression bonding; and forming a circuit pattern on the laminate so as to obtain a double-sided circuit board.

Next, a second method of manufacturing a circuit board according to the present invention includes: laminating a mold release film on at least one side of a composite material (prepreg), the prepreg being formed of an electrically insulating material made of a core material and a thermosetting resin that is impregnated into the core material and brought to a semi-cured state, the mold release film containing or being coated with a heat absorbing substance having a heat absorbing property; forming through-holes in predetermined positions in a member for a circuit board using a laser, which is obtained by allowing the mold release film to adhere to the prepreg by heating and pressing at a temperature not lower than a softening point of the prepreg and not higher than an endothermic temperature of the heat absorbing substance; filling the through-holes with a conductive paste; taking out the prepreg by peeling the mold release film off of the member in which the conductive paste is filled; separately preparing at least two circuit boards that have at least two circuit patterns; alternately arranging the circuit boards and a number of the prepregs, the number of the prepregs exceeding a number of the circuit boards by one; further placing metal foil in an outermost position and subsequently performing heating and pressing so that a laminate is formed; and forming a circuit pattern on the laminate so as to obtain a multilayer circuit board.

### BRIEF DESCRIPTION OF THE DRAWINGS

FIG. 1 is a schematic sectional view of a member for a circuit board according to a first embodiment of the present invention.

FIG. 2 is a schematic sectional view of a member for a circuit board according to a second embodiment of the present invention.

FIG. 3 is a schematic sectional view of a member for a circuit board according to a third embodiment of the present invention.

FIGS. 4A to 4F are schematic sectional views showing process steps of a method of manufacturing a double-sided circuit board according to a fourth embodiment of the present invention.

FIGS. 5A to 5H are schematic sectional views showing process steps of a method of manufacturing a multilayer circuit board according to a fifth embodiment of the present invention.

FIGS. 6A to 6H are schematic sectional views showing process steps of a second method of manufacturing a multilayer circuit board according to a sixth embodiment of the present invention.

FIGS. 7A to 7B are schematic sectional views showing a process step of laminating films on a prepreg of Example 1 according to the present invention.

FIG. 8 is a schematic sectional view of a conventional member for a circuit board in which a hole is processed.

FIG. 9 is a schematic sectional view of a member for a circuit board in which a hole is processed of one example according to the present invention.

### DETAILED DESCRIPTION OF THE INVENTION

The present invention provides a member for a circuit board that includes a prepreg and a mold release film that is provided on at least one side of the prepreg. In the member, the mold release film contains or is coated with a heat absorbing substance. In the case where through-holes are formed in a member for a circuit board of this configuration using a laser or the like, heat generated excessively during processing can be absorbed by a heat absorbing substance of a mold release film provided on a prepreg, and the contraction of the mold release film can be prevented or suppressed. The mold release film is formed of a thermoplastic resin film or a thermosetting resin film. A thermosetting resin layer further may be provided in the mold release film. In any of the cases of providing a heat absorbing substance in the film, the thermosetting resin layer, and a resin layer that is provided separately, the contraction of the mold release film can be prevented or suppressed. The use of this member for a circuit board allows a fine structure of a circuit board to be achieved. A layer that does not contain a heat absorbing substance such as, for example, a mold release layer, a resin layer or the like further may be provided in the film, and the above-mentioned effect also can be attained sufficiently in this case.

Furthermore, the member for a circuit board according to the present invention is obtained by allowing the mold release film to adhere to the prepreg by hot roll lamination. In this case, heating is performed at a temperature not lower than a softening point of the prepreg and not higher than an endothermic temperature of the heat absorbing substance for the following reason. That is, at a temperature not higher than the softening point of the prepreg, adhesion between the prepreg and the mold release film is not attained, while at a temperature not lower than the endothermic temperature of the heat absorbing substance, the capability of absorbing heat is destroyed. More preferably, the heating is performed at a temperature in a range of temperatures higher than a softening point of the prepreg by 10 or more degrees and lower than an endothermic temperature of the heat absorbing substance by 10 or more degrees.

Preferably, the mold release film is a film that contains a thermoplastic resin as a main component. Preferably, the film forming the mold release film is made from at least one material selected from the group consisting of: polyethylene naphthalate, polyphenylene sulfite, polyethylene terephthalate, polypropylene, and polyphenylene oxide. The “main component” refers to a material contained in an amount in a range of not less than 65 mass %.

Preferably, the heat absorbing substance is a metal hydrate. Preferably, the metal hydrate is at least one selected from the group consisting of: aluminum hydroxide (endothermic temperature: 250° C.), magnesium hydroxide (endothermic temperature: 350° C.), dawsonite (endothermic temperature: 250° C.), potassium aluminate (endothermic temperature: 260° C.), calcium hydroxide (endothermic temperature: 450° C.), zinc borate (endothermic temperature: 330° C.), kaolin clay (endothermic temperature: 500° C.), and calcium carbonate (endothermic temperature: 875° C.).

A layer containing a thermosetting resin may be provided in the mold release film. Preferably, the thermosetting resin is at least one selected from the group consisting of epoxy resin, phenol resin, polyimide resin, polyester resin, silicone resin, and melamine resin. The thermosetting resin layer of the mold release film may contain a heat absorbing substance. In the case where a metal hydrate is mixed into the thermosetting resin, the metal hydrate is contained in an amount in a range of preferably, more than 0 mass % to 95 mass %, and more preferably, not less than 1 mass % to not more than 90 mass %.

Preferably, the heat absorbing substance contained in the thermosetting resin layer of the mold release film is at least one selected from the group consisting of: aluminum hydroxide, magnesium hydroxide, dawsonite, potassium aluminate, calcium hydroxide, zinc borate, kaolin clay, and calcium carbonate.

The mold release film further may include a resin layer containing a heat absorbing substance as well as a thermosetting resin layer and a film layer. Preferably, the resin layer containing the heat absorbing substance is formed from at least one type of metal hydrate selected from the group consisting of: aluminum hydroxide, magnesium hydroxide, dawsonite, potassium aluminate, calcium hydroxide, zinc borate, kaolin clay, and calcium carbonate.

Preferably, the prepreg is formed of a composite material of a woven fabric or a nonwoven fabric made of organic fibers or inorganic fibers and a thermosetting resin that is impregnated into the woven fabric or the nonwoven fabric and brought to a semi-cured state. Preferably, the organic fibers are heat-resistant organic fibers having a melting point or a decomposition point such that melting or decomposition of the organic fibers does not occur even at a temperature at which a soldering reflow is performed. Further, preferably, an endothermic temperature of the heat absorbing substance is not lower than a softening point of a thermosetting resin impregnated into the prepreg.

In the present invention, preferably, the mold release film contains or is coated with a heat absorbing substance having a heat absorbing property in an amount of more than 0 mass % to not more than 60 mass %. When the heat absorbing substance is contained in an amount of more than 60 mass %, the energy intended primarily for processing is consumed for the processing of the mold release film, which thus may result adversely in, for example, the formation of holes whose diameter is extremely small in their lower portions. For example, when aluminum hydroxide among heat absorbing substances, which has a large heat absorption capacity, is added in an amount of 65% in the mold release film, 5% of energy to be consumed for this processing is consumed for processing the mold release film on one side, resulting in the formation of holes whose diameter is extremely small in their lower portions.

Next, the present invention provides a method of manufacturing a double-sided circuit board that includes: forming through-holes in predetermined positions in the above-mentioned member for a circuit board using a laser; filling the through-holes with a conductive paste; subsequently obtaining a prepreg by peeling off a resin film including at least a metal layer; and sandwiching the prepreg between metal foil sheets and performing pressing and heating. This method allows the manufacturing of a highly reliable double-sided circuit board. In the above-mentioned method, preferably, the pressing is performed at a pressure not lower than 1×10⁶ Pa and not higher than 1×10⁷ Pa, and the heating is performed at a temperature not lower than 150° C. and not higher than 300° C. This also applies to the following case of a multilayer board.

Furthermore, the present invention provides a method of manufacturing a multilayer circuit board that includes: forming through-holes in predetermined positions in the above-mentioned member for a circuit board using a laser; filling the through-holes with a conductive paste;, subsequently obtaining a prepreg by peeling off a resin film including at least a metal layer; alternately arranging a desired number of the prepregs and at least two circuit boards having circuit patterns; and placing metal foil as an outermost layer and performing pressing and heating. This method allows the manufacturing of a highly reliable multilayer circuit board.

Furthermore, the present invention provides a method of manufacturing a multilayer circuit board that includes: forming through-holes in predetermined positions in the member for a circuit board obtained as described above using a laser; filling the through-holes with a conductive paste; taking out the prepreg by peeling the mold release film off of the member in which the conductive paste is filled; separately preparing at least two circuit boards that have at least two circuit patterns; alternately arranging the circuit boards and a number of the prepregs, the number of the prepregs exceeding a number of the circuit boards by one; further placing metal foil in an outermost position and subsequently performing heating and pressing so that a laminate is formed; and forming a circuit pattern on the laminate so as to obtain a multilayer circuit board. This method allows the manufacturing of a highly reliable multilayer circuit board.

According to the present invention, in the case where through-holes are formed in this member for a circuit board using a laser or the like, heat generated excessively during processing can be absorbed by a heat absorbing layer of the mold release film provided on the prepreg, and thus the contraction of the mold release film can be suppressed or prevented. Thus, the use of this member for a circuit board allows small-diameter via holes of a circuit board to be achieved.

Furthermore, by using the method of forming a member for a circuit board and either of the methods of manufacturing a double-sided and multilayer circuit boards according to the present invention, a fine structure of a double-sided or multilayer circuit board can be achieved.

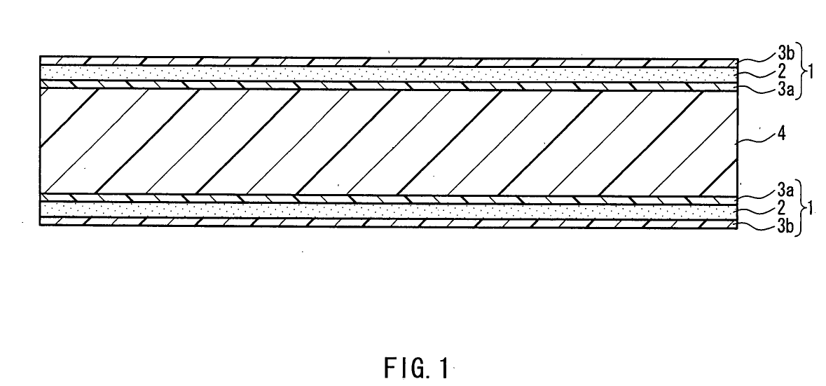

Hereinafter, the member for a circuit board according to the present invention will be described by way of embodiments with reference to FIGS. 1 to 3.

### FIRST EMBODIMENT

FIG. 1 is a schematic sectional view of a member for a circuit board according to the present invention in which a mold release film is provided on each surface of a prepreg and a heat absorbing substance is contained in a resin film of the mold release film. In FIG. 1, reference characters 1 and 2 denote a mold release film provided with a heat absorbing layer and a resin film containing a heat absorbing substance, respectively. Reference characters 3a and 3b denote thermosetting resin layers, and reference character 4 denotes a prepreg. In the case where through-holes are formed in a member for a circuit board having a configuration according to this embodiment using a laser or the like, heat generated excessively during processing can be absorbed by the resin film 2 containing the heat absorbing substance, and the contraction of the mold release film 1 can be suppressed. Moreover, in this embodiment, the thermosetting resin layers 3a and 3b are provided on surfaces of the resin film 2 containing the heat absorbing substance, and thus the deterioration of vias that occurs when peeling off the mold release film can be reduced by the resin layers. Preferably, the thermosetting resin layers 3a and 3b are formed from a thermosetting resin. Specifically, at least one type of resin selected from the group consisting of epoxy resin, phenol resin, polyimide resin, polyester resin, silicone resin, and melamine resin is used preferably. The resin layers have a thickness of generally, 0.01 μm to 20 μm and preferably, 0.1 μm to 5 μm.

The mold release film having the configuration according to the first embodiment can contain an increased amount of a heat absorbing substance. Further, the mold release film can be set to have the same thickness as in the conventional technique.

### SECOND EMBODIMENT

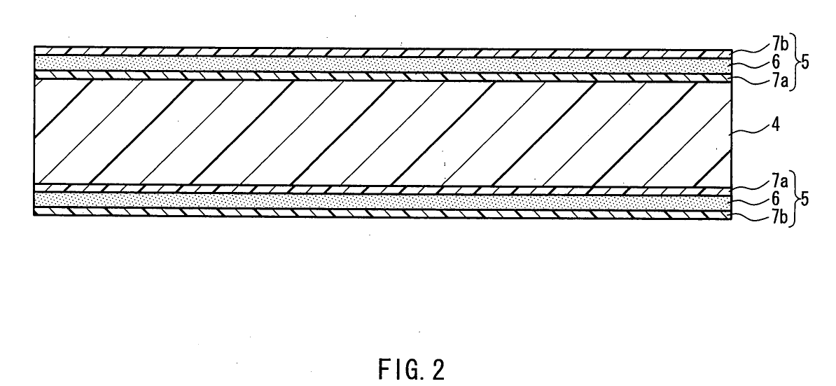

FIG. 2 is a schematic sectional view of a member for a circuit board according to the present invention in which a mold release film is provided on each surface of a prepreg and a heat absorbing substance is contained in a thermosetting resin layer. In FIG. 2, a mold release film 5 is composed of a resin film 6 and thermosetting resin layers 7a and 7b, each containing a heat absorbing substance. In the case where through-holes are formed in a member for a circuit board having a configuration according to this embodiment using a laser or the like, heat generated excessively during processing can be absorbed by the thermosetting resin layers 7a and 7b, each containing the heat absorbing substance, and the contraction of the resin film 6 can be suppressed. Thus, in order to allow these effects to be exerted, it is sufficient to have the thermosetting resin layer 7a or 7b that contains the heat absorbing substance, and this embodiment also may be achieved by including only one heat absorbing layer.

The mold release film having the configuration according to the second embodiment further can reduce the deterioration of vias that occurs when peeling off the mold release film. Further, the mold release film can be set to have the same thickness as in the conventional technique.

### THIRD EMBODIMENT

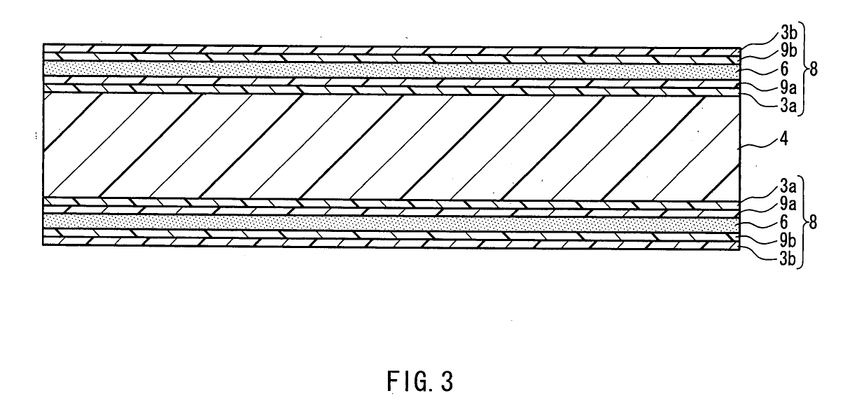

FIG. 3 is a schematic sectional view of a member for a circuit board according to the present invention in which a mold release film is provided on each surface of a prepreg and a heat absorbing substance is contained in the mold release film. In FIG. 3, reference characters 8 and 6 denote a mold release film provided with resin layers, each containing a heat absorbing substance, and a resin film of the mold release film, respectively. Reference characters 9a and 9b denote the resin layers, each containing a heat absorbing substance. Reference characters 3a and 3b denote thermosetting resin layers, and reference character 4 denotes a prepreg. In the case where through-holes are formed in a member for a circuit board having a configuration according to this embodiment using a laser or the like, heat generated excessively during processing can be absorbed by the resin layers 9a and 9b, each containing the heat absorbing substance, and the contraction of the resin film 6 can be suppressed. Thus, in order to allow these effects to be exerted, it is sufficient to have the resin layers 9a and 9b each containing the heat absorbing substance, and the present invention also may be achieved by including only one heat absorbing layer.

The mold release film having the configuration according to the third embodiment allows the respective properties and manufacturing methods of the resin film and the thermosetting resin layers to be maintained.

In the above-mentioned first to third embodiments, as a substance forming these heat absorbing layers, a metal hydrate can be used so that the thermal decomposition thereof can be utilized. As a metal hydrate, aluminum hydroxide, magnesium hydroxide, dawsonite, potassium aluminate, calcium hydroxide, zinc borate, kaolin clay, calcium carbonate, and the like can be used. However, a metal hydrate that can be used is not limited thereto. Preferably, the content of these metal hydrates is in a range of more than 0 mass % to not more than 60 mass % with respect to the film formed from a crystalline polymer.

Furthermore, in each of the first to third embodiments, as the prepreg 4, a prepreg that is used commonly as a material of an insulating layer of a circuit board can be used. It is preferable to use a composite material formed of a woven or nonwoven fabric containing at least one of heat-resistant organic fibers (aramid fibers, for example) and inorganic fibers (glass fibers, for example) as a main component, which is impregnated with a thermosetting resin (epoxy resin, for example) that further is semi-cured. Further, as a nonwoven fabric, heat-resistant organic fibers and/or inorganic fibers that are bound with a thermosetting resin such as epoxy resin, melamine resin or the like, a thermoplastic resin, or thermally meltable pulp or fibers can be used. Specifically, heat-resistant organic fibers can be of at least one material selected from the group consisting of: aromatic polyamide (aramid), wholly aromatic polyester, polyphenylene bis-oxazole (PBO), polyphenylene bis-thiazole (PBZ), and the like. Further, the prepreg 4 may be formed of a highly heat-resistant resin film with an adhesive layer in a semi-cured state provided on each surface thereof. Specifically, the prepreg 4 may be formed of a polyimide film or an aramid film. In this case, a thermosetting adhesive is applied to each surface of the film and brought to a semi-cured state. Alternatively, an adhesive film is laminated on each surface of the film. The prepreg may contain 5 to 80 mass % of an inorganic filer. Preferably, as a material of an inorganic filler, silica, aluminum hydroxide or the like is used. Preferably, as a material of an adhesive, epoxy resin, polyimide resin or the like is used.

Furthermore, in each of the first to third embodiments, as a material of the resin films 2 and 6, polyethylene naphthalate, polyphenylene sulfite, polyethylene terephthalate, polypropylene, polyphenylene oxide or the like can be used. The resin films 2 and 6 have a thickness of generally, 4 μm to 100 μm and preferably, 6 μm to 40 μm.

Furthermore, in each of the first to third embodiments, the films of the same configuration were provided respectively on both surfaces of the prepreg 4. However, this is not necessarily required. For example, the following combination of mold release films may be used. That is, the mold release film 1 including a heat absorbing layer is provided on one surface of the prepreg 4 on a side irradiated with laser beams, and a mold release film including a heat absorbing layer and a mold release layer is provided on an opposite side thereof. The mold release films having the respective configurations according to the first to fourth embodiments can be combined arbitrarily so as to be provided on the prepreg 4.

Furthermore, it also is unnecessary for a mold release film including a heat absorbing layer to be provided on each surface. As a factor that acts adversely when forming small-diameter holes, the contraction of an upper-side mold release film has a larger impact than the contraction of a lower-side mold release film. With this in mind, a configuration in which only an upper-side mold release film includes a heat absorbing layer also is effective.

In the case of using a prepreg that has low thermal processability and exhibits a high aspect ratio when holes are processed, the aspect ratio of the shape of the holes can be improved by using as a mold release film to be provided on a lower surface, a mold release film in which no heat absorbing substance or a reduced amount of a heat absorbing substance is contained. This is because the lower-side mold release film shrinks, so that the holes are increased in size in their lower portions accordingly.

The present invention is not limited to the respective configurations according to the first to third embodiments, and these configurations may be used in combination. For example, the mold release film may be of a configuration in which a heat absorbing substance is contained in each of the resin film and the thermosetting resin layer that constitute the mold release film.

Moreover, a layer other than the above-mentioned layers may be provided in the mold release film. In this case, it is required that at least the mold release film contain a heat absorbing substance.

### FOURTH EMBODIMENT

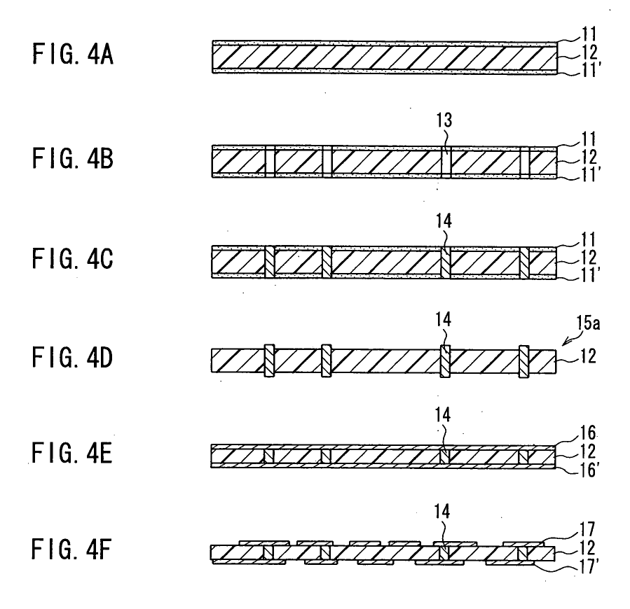

FIGS. 4A-4F show a method of manufacturing a double-sided circuit board as an embodiment of the present invention. First, mold release films 11 and 11′ each provided with a heat absorbing layer are bonded respectively to both surfaces of a prepreg 12 (FIG. 4A). Next, through-holes 13 are formed in predetermined positions using a laser (FIG. 4B), and filled with a conductive paste 14 by a method such as printing or the like (FIG. 4C). Next, the mold release films 11 and 11′ each provided with the heat absorbing layer and the like are peeled off of the prepreg 12, and thus an intermediate connecting body 15a is obtained (FIG. 4D). After the peeling process, metal foil sheets 16 and 16′ are placed respectively on both the surfaces of the prepreg in which the conductive paste is filled. Then, the prepreg and the metal foil sheets on both the surfaces thereof are integrated by heating and pressing, and thus a laminate is obtained (FIG. 4E). Next, circuit patterns 17 and 17′ are formed by processing the metal foil sheets, and thus a double-sided circuit board is obtained (FIG. 4F).

### FIFTH EMBODIMENT

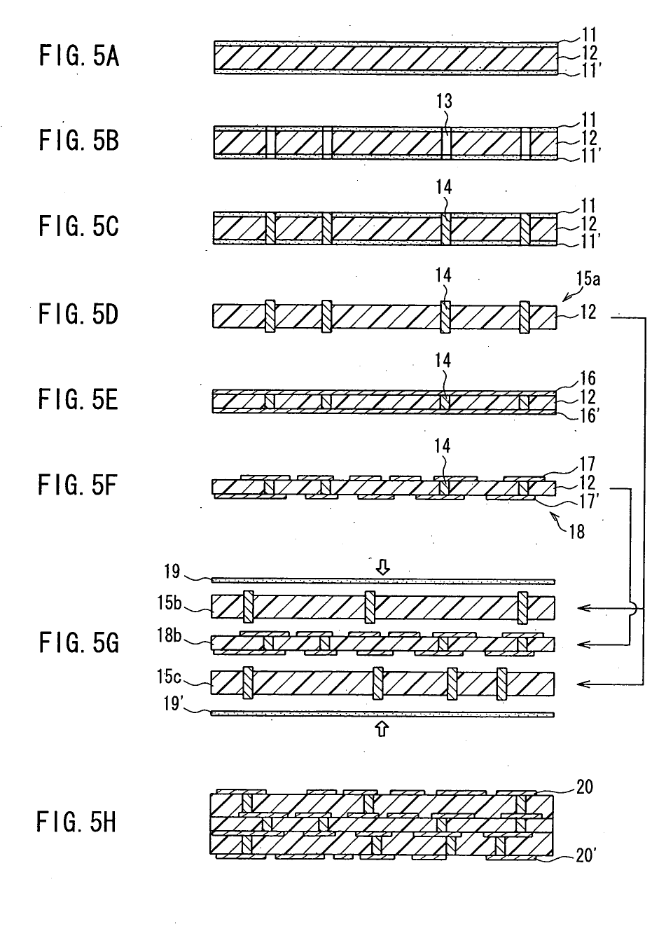

FIGS. 5A-5H show a method of manufacturing a multilayer circuit board as an embodiment of the manufacturing method according to the present invention. First, mold release films 11 and 11′ each provided with a heat absorbing layer are bonded respectively to both surfaces of a prepreg 12 (FIG. 5A). Next, through-holes 13 are formed in predetermined positions using a laser or the like (FIG. 5B), and filled with a conductive paste 14 by a method such as printing or the like (FIG. 5C). Next, the mold release films 11 and 11′ each provided with the heat absorbing layer and the like are peeled off of the prepreg 12, and thus an intermediate connecting body 15a is obtained (FIG. 5D).

Meanwhile, in the same manner as shown in FIGS. 4E to 4F, a double-sided circuit board 18 is obtained (FIGS. 5E to 5F). In FIGS. 5E to 5F, like reference characters indicate like components shown in FIGS. 4E to 4F.

The double-sided circuit board 18 (a circuit board having two or more circuit patterns also may be used) is sandwiched between two intermediate connecting bodies (15b and 15c) that are the same as the intermediate connecting body 15a shown in FIG. 5D, and a body thus obtained further is sandwiched between metal foil sheets 19 and 19′ on both outer sides of the body. Then, the body and the metal foil sheets 19 and 19′ are integrated by heating and pressing, and thus a laminate is obtained (FIG. 5G). Next, circuit patterns are formed by processing the metal foil sheets, and thus a multilayer circuit board is obtained (FIG. 5H). By repeatedly performing these process steps, a circuit board having an increased number of layers can be obtained.

### SIXTH EMBODIMENT

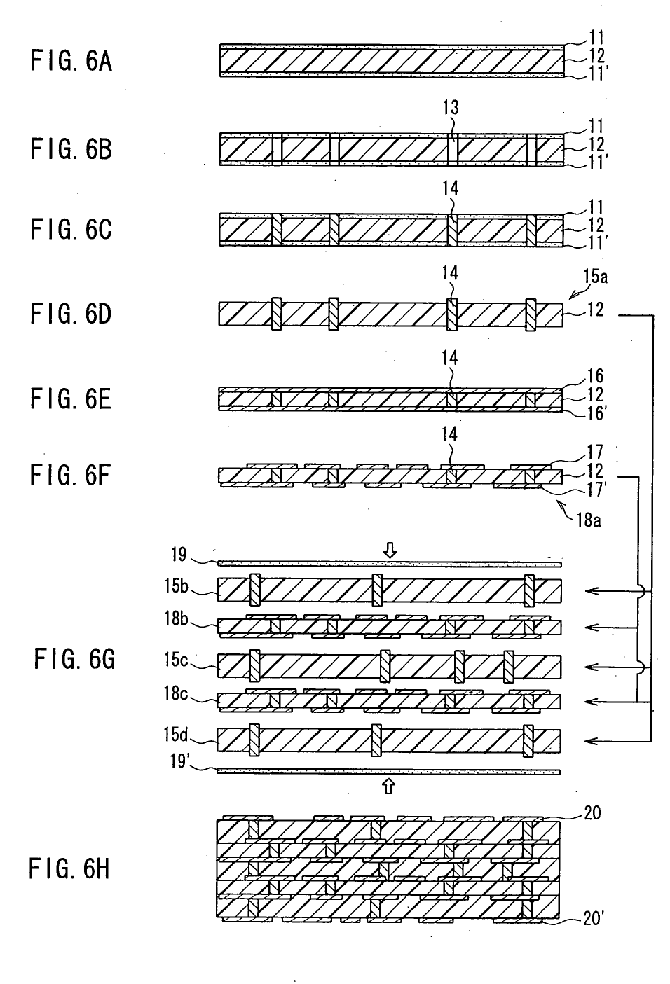

FIGS. 6A to 6H show another method of manufacturing a multilayer circuit board as an embodiment of the present invention. The process steps shown in FIGS. 6A to 6F are the same as those shown in FIGS. 4 and 5, for which duplicate descriptions are omitted. Two or more circuit boards 18b and 18c that have two or more circuit patterns are prepared. Further, prepregs 15b, 15c and 15d in which a paste is filled by the above-mentioned method are prepared. The number of the prepregs 15b, 15c and 15d exceeds the number of the circuit boards by one. The circuit boards 18b and 18c and the prepregs 15b, 15c and 15d further are arranged alternately. Finally, a body thus obtained is sandwiched between metal foil sheets 19 and 19′. Then, the body and the metal foil sheets 19 and 19′ are integrated by heating and pressing, and thus a laminated is obtained (FIG. 6G). Next, circuit patterns are formed by processing the metal foil sheets, and thus a multilayer circuit board is obtained (FIG. 6H). Reference characters 20 and 20′ denote the wiring patterns. By repeatedly performing these process steps, a circuit board having an increased number of layers can be obtained.

In each of the fourth to sixth embodiments, a laser can be used for forming through-holes in predetermined positions in the member for a circuit board. Lasers that can be used include a carbon dioxide gas laser, a YAG laser, an excimer laser and the like.

In each of the fourth to sixth embodiments, preferably, the conductive paste is formed from at least conductive particles and a thermosetting resin. As conductive particles, particles of gold, silver, copper, palladium, indium, tin, zinc, lead or the like can be used. As a thermosetting resin, a liquid thermosetting resin, specifically epoxy resin or the like, is used preferably. Further, a commercially available soldering paste also may be used.

In each of the fourth to sixth embodiments, the metal foil sheets and the prepreg are integrated. In this case, specifically, metal foil of copper is used most preferably. Further, in each of the fourth to sixth embodiments, a double-sided or multilayer circuit board can be obtained in the following manner. That is, using metal foil of, preferably, copper, which has been formed into a circuit pattern on a supporting body by etching, plating or the like, the integration is performed by heating and pressing, and after that, the supporting body is removed. Preferably, the supporting body is formed of a metal plate of aluminum, stainless steel or the like or a heat-resistant mold release film of polyphenylene sulfide (PPS), polyphenylene oxide (PPO) or the like.

As described above, according to the embodiments of the present invention, as shown in FIG. 9, even in the case where a through-hole 13 is formed using high-energy beams of a laser or the like, it is unlikely that the contraction of mold release films 203 and 203′ on both surfaces of a layer 202 formed of an insulating material occurs due to heat generated during processing.

The present invention is not limited to the respective configurations according to the above-mentioned embodiments. Further, the present invention can provide a double-sided or multilayer circuit board obtained by the manufacturing methods according to the present invention. Moreover, in each of the manufacturing methods according to the present invention, the mold release film provided in the member for a circuit board can be used as a mask when filling a conductive paste.

### EXAMPLES

The description is directed to a prepreg used in each of members for a circuit board of Examples 1 to 4 and Comparative Example 1 according to the present invention. Fibers of “KEVLAR”, a trade name of E.I. DuPont (average fiber diameter: 1.67 dtex (1.5 denier), average fiber length: 3 mm) were used to form paper by the wet method, and then an aramid nonwoven fabric (weight per unit area: 72 g/m², thickness: 100 μm) was formed by performing calendaring at a temperature of 300° C. and a pressure of 20 MPa. The nonwoven fabric was impregnated with epoxy resin and dried at a temperature of 130° C. for eight minutes, and thus a prepreg made of a nonwoven fabric impregnated with epoxy resin in a semi-cured state (stage B) was formed. The prepreg that was used had a resin content of 54±1 wt. % and a softening point of 120° C.

Hereinafter, the member for a circuit board according to the present invention will be described by way of examples.

### Example 1

Epoxy resin was applied to each surface of a polyethylene terephthalate film (thickness: 15 μm) containing 5 wt. % of aluminum hydroxide (“HYGILITE”, a trade name of Showa Denko K.K.) and dried so as to have a thickness of 3 μm after drying, and thus a mold release film was obtained.

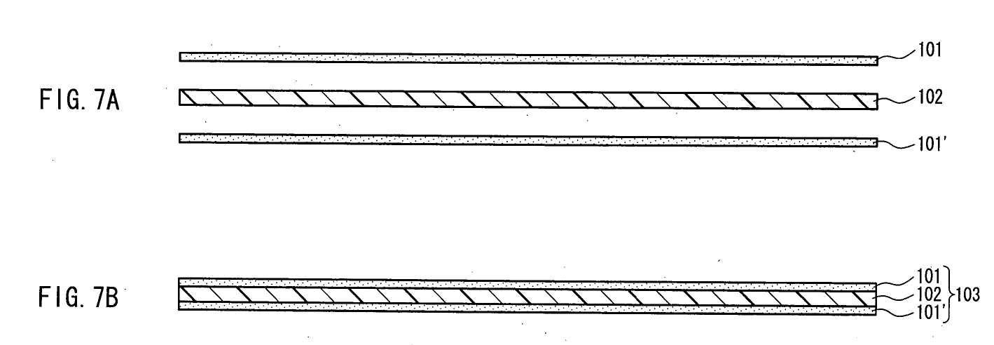

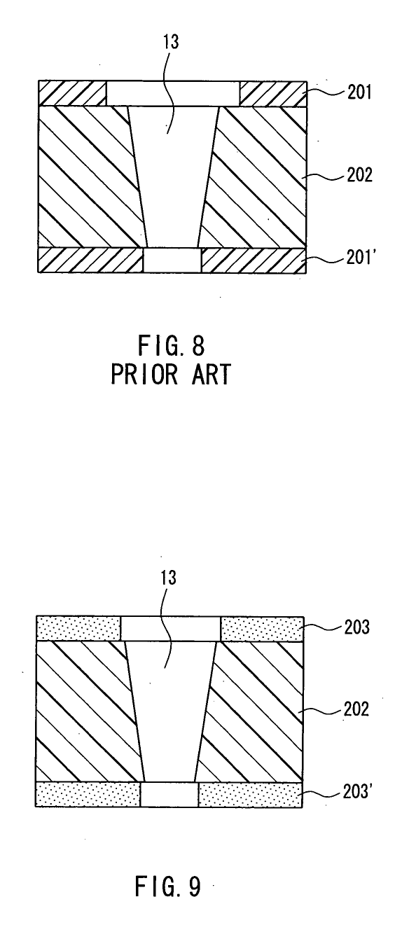

The description is directed to the method of forming the member for a circuit board with reference to FIGS. 7A-7B. FIG. 7A shows the state where mold release films 101 and 101′ are placed respectively on both surfaces of a prepreg 102. FIG. 7B shows the state where integration is performed by hot roll lamination so as to form a member 103 for a circuit board. In this example, the lamination was performed at a temperature of 120° C. and a linear pressure of 3 kg/cm. Further, the thermal decomposition temperature of aluminum hydroxide that was used was 250° C.

### Example 2

Epoxy resin containing 50 wt. % of aluminum hydroxide was applied to each surface of a polyethylene terephthalate film having a thickness of 15 μm and dried so as to have a thickness of 3 μm after drying, and thus a mold release film was obtained. Using the mold release film, a member for a circuit board was formed by the same method as that used in Example 1.

### Example 3

A heat absorbing layer having a thickness of 3 μm was applied to each or either of surfaces of a polyethylene terephthalate film having a thickness of 15 μm, and thus a mold release film was obtained. Aluminum hydroxide was used by being mixed into epoxy resin so as to attain a content of 50 wt. %. Using the mold release film, a member for a circuit board was formed by the same method as that used in Example 1.

### Example 4

A heat absorbing layer having a thickness of 3 μm was applied to each surface of a polyethylene terephthalate film having a thickness of 15 μm. The heat absorbing layer was formed of a mixture of 50 wt. % of gypsum dihydrate and epoxy resin. On each surface of a laminate of the film and the heat absorbing layers, epoxy resin was applied and dried, and thus a mold release film was obtained. Using the mold release film, a member for a circuit board was formed by the same method as that used in Example 1. The thermal decomposition temperature of gypsum dihydrate that was used was 125° C.

### Comparative Example 1

Epoxy resin was applied to each surface of a polyethylene terephthalate film having a thickness of 15 μm and dried, and thus a mold release film was obtained. Using the mold release film, a member for a circuit board was formed by the same method as that used in Example 1.

The description is directed to a prepreg used in each of members for a circuit board of Examples 5 to 7 and Comparative Examples 2 to 3. Glass cloth (cloth thickness: 80 μm, #3313) manufactured by Asahi-Schwebel Co., Ltd. was impregnated with epoxy resin containing 30 vol. % of a filler (silica) and dried at a temperature of 130° C. for eight minutes, and thus a prepreg made of a nonwoven fabric impregnated with epoxy resin in a semi-cured state (stage B) was formed. The prepreg that was used had a resin content of 54±1 wt. % and a softening point of 130° C.

### Example 5

A member for a circuit board was formed in the same manner as in the case of Example 1 except that the above-mentioned prepreg was used. In this case, however, the roll lamination was performed at a temperature of 135° C.

### Example 6

A member for a circuit board was formed in the same manner as in the case of Example 2 except that the above-mentioned prepreg was used. In this case, however, the roll lamination was performed at a temperature of 135° C.

### Example 7

A member for a circuit board was formed in the same manner as in the case of Example 3 except that the above-mentioned prepreg was used. In this case, however, the roll lamination was performed at a temperature of 135° C.

### Comparative Example 2

A member for a circuit board was formed in the same manner as in the case of Example 4 except that the above-mentioned prepreg was used. In this case, however, the roll lamination was performed at a temperature of 135° C.

### Comparative Example 3

A member for a circuit board was formed in the same manner as in the case of Comparative Example 1 except that the above-mentioned prepreg was used. In this case, however, the roll lamination was performed at a temperature of 135° C.

Through-holes of 150 μm in diameter were formed in each of the members for a circuit board of Examples 1 to 7 and Comparative Examples 1 to 3 using a carbon dioxide gas laser. With respect to materials of a circuit board, energy of 25 mJ was used in each of Examples 1 to 4 and Comparative Example 1, and energy of 50 mJ was used in each of Examples 5 to 7 and Comparative Examples 2 to 3. Then, with respect to each of these examples, the diameter of the through-holes in the mold release film and the diameter of the through-holes in the prepreg were measured, and the ratio of these diameters was determined. The results are shown in Table 1. As for the ratio of the diameters (diameter of the through-holes in the film/diameter of the through-holes in the prepreg), the more the ratio approximates 1, the lower the degree of contraction of the mold release film, thereby being effective at forming smaller-diameter via holes of a circuit board.

TABLE 1

| | | Thermal | | Surface(s) | |
|---|---|---|---|---|---|
| | | decomposition | | on | |
| | | temperature of | Softening | which heat | |
| | | heat absorbing | temperature | absorbing | |
| | Sample | substance | of resin in | layer is | Contrac- |
| | No. | (° C.) | prepreg (° C.) | formed | tion |
| Ex. 1 | 1 | 250 | 120 | — | A |
| Ex. 2 | 2 | 250 | 120 | Both | A |
| Ex. 3 | 3 | 250 | 120 | One | A |
| | 4 | 250 | 120 | Both | A |
| Ex. 4 | 5 | 125 | 120 | Both | A |
| Com. | 6 | — | 120 | — | B |
| Ex. 1 | | | | | |
| Ex. 5 | 7 | 250 | 130 | — | A |
| Ex. 6 | 8 | 250 | 130 | Both | A |
| Ex. 7 | 9 | 250 | 130 | One | A |
| | 10 | 250 | 130 | Both | A |
| Com. | 11 | 125 | 130 | Both | F |
| Ex. 2 | | | | | |
| Com. | 12 | — | 130 | — | F |
| Ex. 3 | | | | | |

(Note)
Contraction: The ratio of (diameter of holes in a film)/(diameter of holes in a prepreg) was determined.
A = 1.0 to lower than 1.1
B = 1.1 to lower than 1.2
F = 1.2 or higher

As is apparent from Table 1, in each of the members for a circuit board of Examples (Sample Nos. 1 to 5) according to the present invention, the contraction of the mold release film caused during laser processing could be suppressed or prevented. Further, it was observed that the effect was attained regardless of whether the heat absorbing layer was formed on each or only one of the surfaces. The prepreg used for each of Sample Nos. 1 to 5 is formed only from organic substances. The difference in the processing threshold values between this prepreg and the mold release film is small, thereby allowing the laser processing to be performed using lower energy. Because of this, the degree of the contraction exhibited in Comparative Example 1 was, while being increased compared with the cases of Examples, suppressed to a ratio lower than 1.15.

As shown in Table 1, in each of the members for a circuit board of Examples (Sample Nos. 7 to 10) according to the present invention, the contraction of the mold release film caused during laser processing could be prevented. In the member for a circuit board of Comparative Example 2 (Sample No. 11), the contraction of the mold release film caused during laser processing was not suppressed for the following reason. That is, the endothermic temperature of the heat absorbing substance is lower than the softening temperature of the resin in the prepreg. Based on the softening temperature of the resin in the prepreg, the temperature at which the lamination of the mold release film is performed is determined. In Comparative Example 2, when the lamination is performed at a temperature higher than the endothermic temperature of the heat absorbing substance, the heat absorbing substance is decomposed thermally. The thermal decomposition is an irreversible reaction, and thus an endothermic reaction was not caused during the laser processing. The prepreg used for each of Sample Nos. 7 to 10 is formed from organic and inorganic substances. The difference in the processing threshold values between this prepreg and the mold release film is large, thereby requiring higher energy to perform laser processing. Because of this, Comparative Examples 2 and 3 exhibit a higher degree of contraction.

As described above, regardless of whether the heat absorbing substance layer is formed on each or either of the surfaces, the contraction of the mold release film in the member for a circuit board can be suppressed. In this case, it is preferable that the endothermic temperature of a substance that is used is higher than the softening temperature of the resin in the prepreg. The present invention is not limited to the respective configurations of Examples according to the present invention. The member for a circuit board can be of any configuration as long as the configuration is characterized in that a mold release film is provided on at least one side of a prepreg, and a heat absorbing substance is contained in the mold release film.

Next, the method of manufacturing a double-sided circuit board according to the present invention will be described by way of examples.

### Example 8

Through-holes of 150 μm in diameter were formed in the member for a circuit board (Sample No. 1) formed in Example 1 using a carbon dioxide gas laser, and filled with the above-mentioned conductive paste by the printing method. Next, the prepreg in which the conductive paste was filled was sandwiched between copper foil sheets of 18 μm in thickness. Then, the prepreg and the copper foil sheets were subjected to heating and pressing at a temperature of 200° C. and a pressure of 5 MPa in a vacuum for about one hour using a hot press, and thus a laminate was obtained. A dry film was laminated on each surface of the laminate using a hot roll, and a mask film having a desired pattern was placed thereon. Then, exposure to ultraviolet light was performed so that only portions of the films in circuit pattern areas were cured. After that, uncured portions of the films were removed by developing, and portions of the copper foil sheets in areas other than the circuit pattern areas were etched using an aqueous solution of copper chloride. Finally, portions of the films in the circuit pattern areas were peeled off, and thus a double-sided circuit board was fabricated.

### Example 9

A double-sided circuit board was fabricated by the same method as that used in Example 8 except that the member for a circuit board (Sample No. 2) formed in Example 2 was used.

### Example 10

A double-sided circuit board was fabricated by the same method as that used in Example 8 except that the member for a circuit board (Sample Nos. 3 and 4) formed in Example 3 was used.

### Example 11

A double-sided circuit board was fabricated by the same method as that used in Example 8 except that the member for a circuit board (Sample No. 5) formed in Example 4 was used.

### Comparative Example 4

A double-sided circuit board was fabricated by the same method as that used in Example 8 except that the member for a circuit board (Sample No. 6) formed in Comparative Example 1 was used.

### Example 12

A double-sided circuit board was fabricated by the same method as that used in Example 8 except that the member for a circuit board (Sample No. 7) formed in Example 5 was used.

### Example 13

A double-sided circuit board was fabricated by the same method as that used in Example 8 except that the member for a circuit board (Sample No. 8) formed in Example 6 was used.

### Example 14

A double-sided circuit board was fabricated by the same method as that used in Example 8 except that the member for a circuit board (Sample Nos. 9 and 10) formed in Example 7 was used.

### Comparative Example 5

A double-sided circuit board was fabricated by the same method as that used in Example 8 except that the member for a circuit board (Sample No. 11) formed in Comparative Example 2 was used.

### Comparative Example 6

A double-sided circuit board was fabricated by the same method as that used in Example 8 except that the member for a circuit board (Sample No. 12) formed in Comparative Example 3 was used.

With respect to each of the above-mentioned double-sided circuit boards fabricated in Examples 8 to 15 and Comparative Examples 4 to 6, the copper foil sheets as outermost layers were peeled off thoroughly by etching. The diameter of the via holes at their surfaces obtained in this case was measured and evaluated. The results are shown in Table 2.

TABLE 2

| | Sample No. | Diameter of vias (μm) |
|---|---|---|
| Ex. 8 | 1 | 200 |
| Ex. 9 | 2 | 201 |
| Ex. 10 | 3 | 199 |
| | 4 | 200 |
| Ex. 11 | 5 | 201 |
| Com. Ex. 4 | 6 | 215 |
| Ex. 12 | 7 | 200 |
| Ex. 13 | 8 | 198 |
| Ex. 14 | 9 | 200 |
| | 10 | 199 |
| Com. Ex. 5 | 11 | 225 |
| Com. Ex. 6 | 12 | 228 |

The diameter of vias shown in Table 2 represents an average value of measured diameters of 100 via holes. As a result, in Comparative Examples 4, 5 and 6, vias had large diameters compared with the cases of Examples according to the present invention. Thus, by the use of Examples according to the present invention, connection using small-diameter vias can be achieved. Further, by using each of the members for a circuit board of Examples according to the present invention and further fabricating a double-sided circuit board by each of the manufacturing methods of Examples according to the present invention, a double-sided circuit board having a fine wiring structure can be provided.

### Example 15

Hereinafter, the method of manufacturing a multilayer circuit board according to the present invention will be described.

Through-holes of 150 μm in diameter were formed in the member for a circuit board (Sample No. 1) formed in Example 1 using a carbon dioxide gas laser, and filled with the above-mentioned conductive paste by the printing method. Subsequently, the mold release films were peeled off, and thus an intermediate connecting body was formed. Next, the above-mentioned glass epoxy double-sided circuit board was sandwiched between two intermediate connecting bodies, and a body thus obtained further was sandwiched between two copper foil sheets of 18 μm in thickness at its outermost layers. Then, the body and the copper foil sheets were subjected to heating and pressing at a temperature of 200° C. and a pressure of 5 MPa in a vacuum for about an hour using a hot press, and thus a laminate was obtained. A dry film was laminated on each surface of the laminate using a hot roll, and a mask film having a desired pattern was placed thereon. Then, exposure to ultraviolet light was performed so that only portions of the films in circuit pattern areas were cured. After that, uncured portions of the films were removed by developing, and portions of the copper foil sheets in areas other than the circuit pattern areas were etched using an aqueous solution of copper chloride. Finally, portions of the films in the circuit pattern areas were peeled off, and thus a four-layer circuit board was fabricated. In this manufacturing method, by using the four-layer circuit board fabricated by this manufacturing method instead of a glass epoxy double-sided circuit board, a six-layer circuit board can be fabricated. Moreover, by repeatedly performing this manufacturing method, a multilayer board having a desired number of layers can be obtained. Further, instead of a glass epoxy double-sided circuit board, a glass epoxy multilayer circuit board, or either of double-sided and multilayer circuit boards obtained by the manufacturing methods according to the present invention can be used.

### Example 16

A multilayer circuit board was fabricated by the same method as that used in Example 15 except that the member for a circuit board (Sample No. 5) formed in Example 2 was used.

### Example 17

A multilayer circuit board was fabricated by the same method as that used in Example 15 except that the member for a circuit board (Sample Nos. 9 to 16) formed in Example 3 was used.

### Example 18

A multilayer circuit board was fabricated by the same method as that used in Example 15 except that the member for a circuit board (Sample No. 17) formed in Example 4 was used.

### Comparative Example 7

A multilayer circuit board was fabricated by the same method as that used in Example 15 except that the member for a circuit board (Sample No. 21) formed in Comparative Example 1 was used.

### Example 19

A multilayer circuit board was fabricated by the same method as that used in Example 15 except that the member for a circuit board (Sample No. 24) formed in Example 5 was used.

### Example 20

A multilayer circuit board was fabricated by the same method as that used in Example 15 except that the member for a circuit board (Sample No. 28) formed in Example 6 was used.

### Example 21

A multilayer circuit board was fabricated by the same method as that used in Example 15 except that the member for a circuit board (Sample Nos. 30 to 37) formed in Example 7 was used.

### Comparative Example 8

A multilayer circuit board was fabricated by the same method as that used in Example 15 except that the member for a circuit board (Sample No. 30) formed in Comparative Example 2 was used.

### Comparative Example 9

A multilayer circuit board was fabricated by the same method as that used in Example 15 except that the member for a circuit board (Sample No. 32) formed in Comparative Example 3 was used.

With respect to each of the above-mentioned multilayer circuit boards fabricated in Examples 15 to 21 and Comparative Examples 7 to 9, the copper foil sheets as outermost layers were peeled off thoroughly by etching. The diameter of via holes at their surfaces obtained in this case was measured and evaluated. The results are shown in Table 3.

TABLE 3

| | Sample No. | Diameter of vias (μm) |
|---|---|---|
| Ex. 15 | 1 | 201 |
| Ex. 16 | 2 | 200 |
| Ex. 17 | 3 | 202 |
| | 4 | 200 |
| Ex. 18 | 5 | 202 |
| Com. Ex. 7 | 6 | 220 |
| Ex. 19 | 7 | 201 |
| Ex. 20 | 8 | 200 |
| Ex. 21 | 9 | 200 |
| | 10 | 200 |
| Com. Ex. 8 | 11 | 230 |
| Com. Ex. 9 | 12 | 231 |

The diameter of vias shown in Table 3 represents an average value of measured diameters of 100 via holes. As a result, in Comparative Examples 7, 8 and 9, vias have large diameters compared with the cases of Examples according to the present invention. Thus, by the use of Examples according to the present invention, connection using small-diameter vias can be achieved, and a multilayer circuit board having a fine wiring structure can be provided.

### Example 22

Through-holes of 150 μm in diameter were formed in the member for a circuit board (Sample No. 1) formed in Example 1 using a carbon dioxide gas laser, and filled with the above-mentioned conductive paste by the printing method. Subsequently, the mold release films were peeled off, and thus an intermediate connecting body was formed. Next, the intermediate connecting body was sandwiched between the two above-mentioned glass epoxy double-sided circuit boards, and the circuit boards interposing the intermediate connecting body between them were sandwiched between two other intermediate connecting bodies of the same configuration on their both outer sides. Then, a body thus obtained further was sandwiched between two copper foil sheets of 18 μm in thickness on its both outer sides. Then, the body and the copper foil sheets were subjected to heating and pressing at a temperature of 200° C. and a pressure of 5 MPa in a vacuum for about an hour using a hot press, and thus a laminate was obtained. A dry film was laminated on each surface of the laminate using a hot roll, and a mask film having a desired pattern was placed thereon. Then, exposure to ultraviolet light was performed so that only portions of the films in circuit pattern areas were cured. After that, uncured portions of the films were removed by developing, and portions of the copper foil sheets in areas other than the circuit pattern areas were etched using an aqueous solution of copper chloride. Finally, portions of the films in the circuit pattern areas were peeled off, and thus a six-layer circuit board was fabricated. By this manufacturing method, a multilayer circuit board having a desired number of layers can be manufactured in the following manner. That is, a desired number of glass epoxy double-sided or multilayer circuit boards and intermediate connecting bodies are arranged alternately, and finally, a body thus obtained is sandwiched between copper foil sheets. Further, a double-sided or multilayer circuit board obtained by the manufacturing methods according to the present invention can be used.

### Example 23

A multilayer circuit board was fabricated by the same method as that used in Example 22 except that the member for a circuit board (Sample No. 2) formed in Example 2 was used.

### Example 24

A multilayer circuit board was fabricated by the same method as that used in Example 22 except that the member for a circuit board (Sample Nos. 3 and 4) formed in Example 3 was used.

### Example 25

A multilayer circuit board was fabricated by the same method as that used in Example 22 except that the member for a circuit board (Sample No. 5) formed in Example 4 was used.

### Comparative Example 10

A multilayer circuit board was fabricated by the same method as that used in Example 22 except that the member for a circuit board (Sample No. 6) formed in Comparative Example 1 was used.

### Example 26

A multilayer circuit board was fabricated by the same method as that used in Example 22 except that the member for a circuit board (Sample No. 7) formed in Example 5 was used.

### Example 27

A multilayer circuit board was fabricated by the same method as that used in Example 22 except that the member for a circuit board (Sample No. 8) formed in Example 6 was used.

### Example 28

A multilayer circuit board was fabricated by the same method as that used in Example 22 except that the member for a circuit board (Sample Nos. 9 and 10) formed in Example 7 was used.

### Comparative Example 11

A multilayer circuit board was fabricated by the same method as that used in Example 22 except that the member for a circuit board (Sample No. 11) formed in Comparative Example 2 was used.

### Comparative Example 12

A multilayer circuit board was fabricated by the same method as that used in Example 22 except that the member for a circuit board (Sample No. 12) formed in Comparative Example 3 was used.

With respect to each of the above-mentioned multilayer circuit boards fabricated in Examples 22 to 28 and Comparative Examples 10 to 12, the copper foil sheets as outermost layers were peeled off thoroughly by etching. The diameter of via holes at their surface obtained in this case was measured and evaluated. The results are shown in Table 4.

TABLE 4

| | Sample No. | Diameter of vias (μm) |
|---|---|---|
| Ex. 22 | 1 | 200 |
| Ex. 23 | 2 | 201 |
| Ex. 24 | 3 | 200 |
| | 4 | 200 |
| Ex. 25 | 5 | 202 |
| Com. Ex. 10 | 6 | 220 |
| Ex. 26 | 7 | 200 |
| Ex. 27 | 8 | 200 |
| Ex. 28 | 9 | 201 |
| | 10 | 200 |
| Com. Ex. 11 | 11 | 230 |
| Com. Ex. 12 | 12 | 232 |

The diameter of vias shown in Table 4 represents an average value of measured diameters of 100 via holes. As a result, in Comparative Examples 10, 11 and 12, vias have large diameters compared with the cases of Examples according to the present invention. Thus, by the use of Examples according to the present invention, connection using small-diameter vias can be achieved, and a multilayer circuit board having a fine wiring structure can be provided.

Furthermore, by using each of the members for a circuit board of Examples according to the present invention and further fabricating a double-sided circuit board by each of the manufacturing methods of Examples according to the present invention, a double-sided circuit board having a fine wiring structure can be provided.

The methods of manufacturing double-sided and multilayer circuit boards according to the present invention are not limited to the manufacturing methods of Examples according to the present invention.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A member for a circuit board, comprising:
an electrically insulating material; and
a mold release film that is provided on at lease one side of the electrically insulating material,
wherein the mold release film contains or is coated with a heat absorbing substance having a heat absorbing property.

2. The member according to claim 1,
wherein the heat absorbing substance is a metal hydrate.

3. The member according to claim 2,
wherein the metal hydrate is at least one selected from the group consisting of: aluminum hydroxide, magnesium hydroxide, dawsonite, potassium aluminate, calcium hydroxide, zinc borate, kaolin clay, and calcium carbonate.

4. The member according to claim 1,
wherein the mold release film is formed of a film of a thermoplastic resin or a thermosetting resin.

5. The member according to claim 4,
wherein the thermoplastic resin is at least one selected from the group consisting of: polyethylene naphthalate, polyphenylene sulfite, polyethylene terephthalate, polypropylene, and polyphenylene oxide.

6. The member according to claim 4,
wherein the thermosetting resin is at least one selected from the group consisting of: epoxy resin, phenol resin, polyimide resin, polyester resin, silicone resin, and melamine resin.

7. The member according to claim 1,
wherein a layer containing a thermosetting resin further is provided in the mold release film.

8. The member according to claim 7,
wherein the thermosetting resin layer of the mold release film contains a heat absorbing substance.

9. The member according to claim 8,
wherein the heat absorbing substance contained in the thermosetting resin layer of the mold release film is at least one selected from the group consisting of: aluminum hydroxide, magnesium hydroxide, dawsonite, potassium aluminate, calcium hydroxide, zinc borate, kaolin clay, and calcium carbonate.

10. The member according to claim 1,
wherein the mold release film further includes a resin layer containing a heat absorbing substance as well as a thermosetting resin layer and a film layer.

11. The member according to claim 10,
wherein the resin layer containing the heat absorbing substance is formed from at least one type of metal hydrate selected from the group consisting of: aluminum hydroxide, magnesium hydroxide, dawsonite, potassium aluminate, calcium hydroxide, zinc borate, kaolin clay, and calcium carbonate.

12. The member according to claim 1,
wherein the electrically insulating material is formed of a composite material of a woven fabric or a nonwoven fabric containing organic fibers or inorganic fibers as a main component and a thermosetting resin that is impregnated into the woven fabric or the nonwoven fabric and brought to a semi-cured state.

13. The member according to claim 12,
wherein the composite material contains an inorganic filler.

14. The member according to claim 1,
wherein an endothermic temperature of the heat absorbing substance is not lower than a softening point of a thermosetting resin impregnated into the insulating material.

15. The member according to claim 1,
wherein a heat absorbing substance having a heat absorbing property is present in an amount of more than 0 mass % to not more than 60 mass % with respect to the mold release film.

16. The member according to claim 8,
wherein a metal hydrate in an amount in a range of more than 0 mass % to 95 mass % is mixed into the thermosetting resin.

17. A method of manufacturing a member for a circuit board, comprising:
allowing a mold release film to adhere to at least one side of a composite material (hereinafter, referred to as a prepreg) by heating and pressing, the prepreg being formed of an electrically insulating material made of a core material and a thermosetting resin that is impregnated into the core material and brought to a semi-cured state, the mold release film containing or being coated with a heat absorbing substance having a heat absorbing property,
wherein the heating is performed at a temperature not lower than a softening point of the prepreg and not higher than an endothermic temperature of the heat absorbing substance.

18. A method of manufacturing a circuit board, comprising:
laminating a mold release film on at least one side of a composite material (hereinafter, referred to as a prepreg), the prepreg being formed of an electrically insulating material made of a core material and a thermosetting resin that is impregnated into the core material and brought to a semi-cured state, the mold release film containing or being coated with a heat absorbing substance having a heat absorbing property;
forming through-holes in predetermined positions in a member for a circuit board using a laser, the member being obtained by allowing the mold release film to adhere to the prepreg by heating and pressing at a temperature not lower than a softening point of the prepreg and not higher than an endothermic temperature of the heat absorbing substance;
filing the through-holes with a conductive paste;
taking out the prepreg by peeling the mold release film off of the member in which the conductive paste is filled;
placing metal foil on each surface of the prepreg and subsequently performing heating and pressing so that a laminate is formed by thermocompression bonding; and
forming a circuit pattern on the laminate so as to obtain a double-sided circuit board.

19. The method according to claim 18,
wherein process steps of forming the laminate and forming the circuit pattern on a surface of the laminate are performed at least twice repeatedly so as to obtain a multilayer circuit board.

20. A method of manufacturing a circuit board, comprising:
laminating a mold release film on at least one side of a composite material (hereinafter, referred to as a prepreg), the prepreg being formed of an electrically insulating material made of a core material and a thermosetting resin that is impregnated into the core material and brought to a semi-cured state, the mold release film containing or being coated with a heat absorbing substance having a heat absorbing property;
forming through-holes in predetermined positions in a member for a circuit board using a laser, the member being obtained by allowing the mold release film to adhere to the prepreg by heating and pressing at a temperature not lower than a softening point of the prepreg and not higher than an endothermic temperature of the heat absorbing substance;
filling the through-holes with a conductive paste;
taking out the prepreg by peeling the mold release film off of the member in which the conductive paste is filled;
separately preparing at least two circuit boards that have at least two circuit patterns;
alternately arranging the circuit boards and a number of the prepregs, the number of the prepregs exceeding a number of the circuit boards by one;
further placing metal foil in an outermost position and subsequently performing heating and pressing so that a laminate is formed; and
forming a circuit pattern on the laminate so as to obtain a multilayer circuit board.
